(19) United States
(12) Patent Application Publication
(10) Pub. No.: US 2018/0221825 A1
(43) Pub. Date: Aug. 9, 2018

(54) WATER TREATMENT METHOD AND WATER TREATMENT APPARATUS

(71) Applicant: MITSUBISHI ELECTRIC CORPORATION, Chiyoda-ku (JP)

(72) Inventors: Eiji IMAMURA, Chiyoda-ku (JP); Tokiko YAMAUCHI, Chiyoda-ku (JP); Nozomu YASUNAGA, Chiyoda-ku (JP)

(73) Assignee: MITSUBISHI ELECTRIC CORPORATION, Chiyoda-ku (JP)

(21) Appl. No.: 15/746,995

(22) PCT Filed: Mar. 1, 2016
(86) PCT No.: PCT/JP2016/056223

§ 371 Date: Jan. 23, 2018

(30) Foreign Application Priority Data
Aug. 27, 2015 (JP) 2015-167745

(51) Int. Cl. B01D 65/02; C02F 1/44; C02F 3/12; C02F 1/00; B01D 69/02

(52) U.S. Cl. CPC B01D 65/02; C02F 1/44; C02F 3/1273; C02F 1/008; B01D 69/02; B01D 2325/38; B01D 2321/168; C02F 2303/16; C02F 2209/03; C02F 2209/23; B01D 2321/04

(57) ABSTRACT

Provided is a water treatment method, in which a cycle including: a filtration step of filtering water to be treated through a separation membrane from a primary side to a secondary side of the separation membrane; and a backwashing step of washing the separation membrane from the secondary side to the primary side is repeated, the water treatment method including the steps of: injecting, into the separation membrane, ozone to be used in the backwashing step; and when, of the repeated cycles, a previous cycle is defined as a first cycle and a following cycle subsequent to the first cycle is defined as a second cycle, setting an ozone injection amount to be injected in the second cycle to a value equal to or less than an ozone injection amount injected in the first cycle.

### TECHNICAL FIELD

The present invention relates to a water treatment technology using a membrane, and more specifically, to a water treatment method and water treatment apparatus including washing treatment for modification of a hydrophobic membrane.

### BACKGROUND ART

A solid-liquid separation technology involving separating, from water to be treated, pollutants contained in the water to be treated to obtain clean treated water is widely used in water treatment, such as water purification or sewage water treatment.

Examples of the solid-liquid separation technology include: a flocculation technology involving flocculating pollutants contained in water to be treated through addition of a flocculant, to thereby separate the pollutants by gravity sedimentation; and a dissolved air floatation technology involving injecting microbubbles into water to be treated containing flocculated matter to cause the microbubbles to adsorb the flocculated matter thereonto, to thereby separate the flocculated matter through floatation.

However, those technologies have problems in that treatment is unstable because of being strongly affected by the properties of the water to be treated or flocculated matter, a water temperature, water flow, and the like, and an extensive sedimentation tank or floatation separation tank is required.

Meanwhile, in recent years, a membrane filtration technology using a separation membrane has been introduced actively as an alternative for those technologies. In the membrane filtration technology, solid-liquid separation is performed by filtration of water to be treated through a “membrane” having innumerable fine pores on a surface. The membrane is roughly divided into an “inorganic membrane” formed of an inorganic material, such as ceramic, and an “organic membrane” formed of a high-molecular organic polymer.

In the membrane filtration technology, any pollutant having a diameter equal to or more than a pore diameter of the membrane can be securely separated and removed from water to be treated, and highly clean treated water can be stably obtained. However, there has been a problem in that pollutants are accumulated onto the surface of the membrane along with filtration and thus the pores are blocked, and the membrane falls into a state of being difficult to perform filtration. In particular, a hydrophobic organic membrane has a high affinity for a hydrophobic pollutant to be contained in the water to be treated, and blocking is liable to occur, with the result that it is difficult to perform long-term stable filtration.

When blocking occurs in the membrane as described above, it is necessary to recover a filtration capacity of the membrane through washing with a chemical, such as an oxidant. For example, a related-art method involves using ozone as such membrane washing agent (for example, see Patent Literature 1).

Patent Literature 1 is related to a technology in which ozone water is supplied to a membrane module installed in a water treatment apparatus to remove pollutants adhering onto a membrane, to thereby wash the membrane. Further, in Patent Literature 1, a transmembrane pressure difference is measured during filtration of water to be treated, and an ozone supply amount is varied based on the measurement value.

Meanwhile, another related-art method involves hydrophilizing a hydrophobic organic membrane through use of ozone (for example, see Patent Literature 2). In the invention according to Patent Literature 2, the hydrophobic organic membrane is hydrophilized by, for example, immersing the membrane in ozone water to bring the membrane into contact with ozone.

### CITATION LIST

### Patent Literature

[PTL 1] JP 2003-300071 A

[PTL 2] JP 3242983 B2

### SUMMARY OF INVENTION

### Technical Problem

However, the related art has the following problems.

For example, in the technology according to Patent Literature 1, blocking rapidly occurs when a hydrophobic pollutant load extremely rises owing to organic matter or the like in raw water. Therefore, the necessity of frequent washing remains even when the concentration of ozone is adjusted every washing with ozone. After all, it is difficult to perform long-term stable filtration.

Meanwhile, in the technology according to Patent Literature 2, adhesion of the hydrophobic pollutants can be suppressed by hydrophilizing the membrane. However, the method according to Patent Literature 2 achieves a sufficient hydrophilic effect only when the membrane is brought into contact with water containing 10 mg/L of ozone over a long time of 100 hours.

In addition, in the method according to Patent Literature 2, when an attempt is made to complete hydrophilization in a short contact time with ozone, it is necessary to perform pretreatment using an alkaline solvent having a high concentration. Accordingly, when an attempt is made to perform the method by installing a membrane module in an actual water treatment apparatus, there have been problems in that a separate alkali supply facility is required and a large amount of alkaline effluent is generated.

The present invention has been made in order to solve the problems as described above, and an object of the present invention is to provide a water treatment method and a water treatment apparatus which, in a water treatment technology using a hydrophobic organic membrane, enable long-term stable filtration without using special pretreatment and a special facility through modification of the hydrophobic membrane in an extremely short contact time with ozone as compared to those in the related art.

### Solution to Problem

According to one embodiment of the present invention, there is provided a water treatment method, in which a cycle including: a filtration step of filtering water to be treated through a separation membrane from a primary side to a secondary side of the separation membrane; and a backwashing step of washing the separation membrane from the secondary side to the primary side is repeated, the water treatment method including the steps of: injecting, into the separation membrane, ozone to be used in the backwashing step; and when, of the repeated cycles, a previous cycle is defined as a first cycle and a following cycle subsequent to the first cycle is defined as a second cycle, setting an ozone injection amount to be injected in the second cycle to a value equal to or less than an ozone injection amount injected in the first cycle.

According to another embodiment of the present invention, there is provided a water treatment apparatus, in which a cycle including: filtration treatment of filtering water to be treated through a separation membrane; and backwashing treatment of washing the separation membrane is repeated, the water treatment apparatus including: an ozone injection unit configured to inject, into the separation membrane, ozone to be used in the backwashing treatment; and a control unit configured to control an ozone injection amount to be injected into the separation membrane by the ozone injection unit, in which the control unit is configured to control the ozone injection amount so that, when, of the repeated cycles, a previous cycle is defined as a first cycle and a following cycle subsequent to the first cycle is defined as a second cycle, an ozone injection amount in the second cycle is set to a value equal to or less than an ozone injection amount in the first cycle.

### Advantageous Effects of Invention

The present invention has a configuration in which water treatment is performed as follows: a cycle including: a “filtration step” of filtering water to be treated through a hydrophobic organic membrane; and an “ozone injection step” of, after interrupting the filtration step, injecting an ozone-containing fluid into the hydrophobic organic membrane is repeated; and an “ozone injection amount index” obtained by dividing an ozone injection amount in the ozone injection step by an operation time of the filtration step is calculated every cycle, and the ozone injection amount index of the next cycle is set to a value equal to or less than the ozone injection amount index of the current cycle having been calculated. As a result, the water treatment method and the water treatment apparatus which, in a water treatment technology using a hydrophobic organic membrane, enable long-term stable filtration without using special pretreatment and a special facility through modification of the hydrophobic membrane in an extremely short contact time with ozone as compared to those in the related art can be provided.

### BRIEF DESCRIPTION OF DRAWINGS

FIG. 1 is a view for illustrating an entire water treatment system in the case of applying a water treatment apparatus according to a first embodiment of the present invention to an immersed membrane bioreactor.

FIG. 2 is an explanatory view for illustrating an example of an ozone dissolution technique in the first embodiment of the present invention.

FIG. 3 is an explanatory view for illustrating another example of the ozone dissolution technique in the first embodiment of the present invention, which is different from that of FIG. 2.

FIG. 4 is a flowchart for illustrating a series of treatments in a water treatment method according to the first embodiment of the present invention in which a filtration step and an ozone injection step are repeated.

FIG. 5 is a view for illustrating an entire water treatment system in the case of applying a water treatment apparatus according to a second embodiment of the present invention to an immersed membrane bioreactor.

FIG. 6 is a view for illustrating another entire water treatment system in the case of applying the water treatment apparatus according to the second embodiment of the present invention to the immersed membrane bioreactor, which is different from that of FIG. 5.

FIG. 7 is a graph for showing a relationship: between a difference between a concentration A of dissolved organic matter in a biological treatment tank 4 and a concentration B of dissolved organic matter in a treated water tank 8, A-B; and an increasing rate of a transmembrane pressure difference in the second embodiment of the present invention.

### DESCRIPTION OF EMBODIMENTS

Preferred embodiments of a water treatment method and a water treatment apparatus of the present invention are described with reference to the drawings. The present invention is not limited to first and second embodiments described below. For example, a case of applying the present invention to an immersed membrane bioreactor is taken as an example below, but the present invention is not limited thereto and applicable to an external membrane bioreactor in which a membrane module is arranged outside a tank.

Further, the present invention is not targeted exclusively at wastewater treatment, and the effects of the present invention can be obtained when pollutants in water to be treated are separated through use of a hydrophobic organic membrane as a separation membrane, such as in water purification or specified water treatment.

### First Embodiment

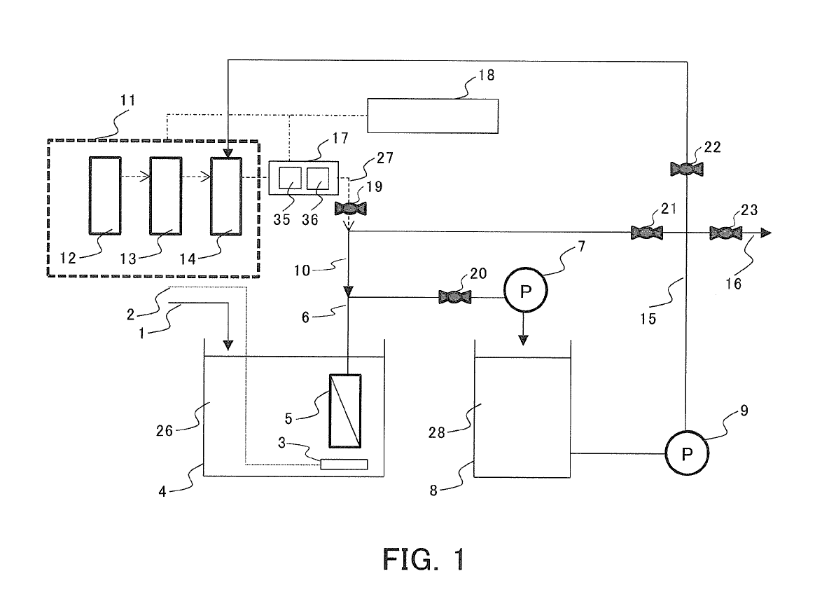

FIG. 1 is a view for illustrating an entire water treatment system in the case of applying a water treatment apparatus according to a first embodiment of the present invention to an immersed membrane bioreactor. The water treatment apparatus of FIG. 1 includes: an introduction pipe 1 for water to be treated for introducing water to be treated into a biological treatment tank 4; an air introduction pipe 2 for blowing air into the biological treatment tank 4. The air introduction pipe 2 is connected to an air diffuser 3.

In the biological treatment tank 4, activated sludge 26 is retained, and in addition, a separation membrane 5 is arranged so as to be immersed in the activated sludge 26. A permeate water transfer pipe 6 is connected to the separation membrane 5. Further, a valve 20 and a membrane filtration pump 7 are mounted to the permeate water transfer pipe 6.

In addition, a treated water transfer pipe 15 is connected to a treated water tank 8 through a pump 9. Moreover, the treated water delivery pump 9 and a valve 22 are mounted to the treated water transfer pipe 15. Further, a treated water discharge pipe 16 and a backwashing pipe 10 are connected to the treated water transfer pipe 15. Moreover, a valve 21 is mounted to the treated water discharge pipe 16, and a valve 23 is mounted to the backwashing pipe 10.

In addition, the water treatment apparatus of FIG. 1 includes an ozone injection device 11. Moreover, the ozone injection device 11 includes an ozone generator 12, an ozone concentrator 13, and an ozone dissolver 14.

An ozone injection pipe 27 is connected to the ozone injection device 11. Moreover, the ozone injection pipe 27 is connected to the backwashing pipe 10. Further, an ozone injection amount measurement device 17 and a valve 19 are mounted to the ozone injection pipe 27. Further, the ozone injection device 11 and the ozone injection amount measurement device 17 are each connected to an ozone injection amount index calculation device 18.

In addition, the ozone injection amount measurement device 17 includes: a measurement unit 35 with which, for an ozone-containing fluid flowing through the ozone injection pipe 27, at least an ozone concentration, a flow rate, and an ozone injection time can be measured; and a computing unit 36 configured to calculate an ozone injection amount from the measurement results.

Next, operation of the water treatment apparatus according to the first embodiment is described.

In the water treatment apparatus according to the first embodiment, there is performed a water treatment method in which a cycle including a “filtration step” of filtering water to be treated through a separation membrane and an “ozone injection step” of, after interrupting the filtration step, injecting an ozone-containing fluid into the hydrophobic organic membrane (an example of a “backwashing step” of the present invention) is repeated.

Moreover, the water treatment method according to the first embodiment has the following feature: an “ozone injection amount index” obtained by dividing an ozone injection amount in the ozone injection step by an operation time of the filtration step is calculated every cycle, and the ozone injection amount index of the next cycle is set to a value equal to or less than the “ozone injection amount index” of the immediately previous cycle serving as a calculation result. In view of the foregoing, the “filtration step” and the “ozone injection step” are each described in detail below.

<Filtration Step>

The filtration step is a step of principally repeating: a filtration operation of water to be treated through the separation membrane 5; and a back pressure washing (hereinafter referred to as backwashing) operation of the separation membrane 5 through use of permeate water 28 accumulated in the treated water tank 8. In view of the foregoing, the filtration operation and the backwashing operation are separately described below, and a determination process for a switching condition from the filtration step to the ozone injection step is also described.

(1) Filtration Operation

Water to be treated is introduced into the biological treatment tank 4 through the introduction pipe 1 for water to be treated. Pollutants contained in water to be treated, such as organic matter, are adsorbed on or decomposed by the activated sludge 26 retained in the biological treatment tank 4, and are thus removed from water to be treated. As a result, water to be treated is purified.

Water to be treated having been purified is sucked by the membrane filtration pump 7 and is simultaneously filtered through the separation membrane 5 to provide the permeate water 28, and the permeate water 28 is transferred to the treated water tank 8 through the permeate water transfer pipe 6 by the membrane filtration pump 7. At this time, the valve 20 is in an open state. Further, the valve 19 and the valve 21 are each in a close state.

The present invention is intended to modify a hydrophobic organic membrane with ozone. Therefore, the separation membrane 5 is a hydrophobic organic membrane. A material of the separation membrane 5 is not limited as long as the separation membrane 5 is a hydrophobic membrane formed of organic matter. Specifically, there are given, for example, polyvinyl fluoride (PVF), polyvinylidene fluoride (PVDF), and a tetrafluoroethylene-ethylene copolymer (ETFE). PVDF is particularly suitable for the separation membrane 5 from the viewpoints of mechanical strength and the like.

In addition, the form of the separation membrane 5 is desirably a form suitable for backwashing, such as a hollow fiber membrane or a tubular membrane. However, a flat membrane may be adopted when a problem in physical strength is solved.

In addition, water to be treated may be any water containing pollutants having a high affinity for the hydrophobic organic membrane, such as urban sewage water, or among industrial effluent, food processing wastewater or wastewater discharged from a semiconductor production process. As long as such water to be treated is adopted, the effects of the present invention can be obtained.

In addition, in FIG. 1, aeration is performed in the biological treatment tank 4 with the air diffuser 3. However, even when a so-called “anaerobic membrane bioreactor” without aeration is adopted, the present invention can be applied. Alternatively, another air diffuser, which is not shown in the figures, configured to generate bubbles each having a smaller diameter than those of bubbles generated with the air diffuser 3 may be arranged for supply to microbes.

(2) Backwashing Operation

After a lapse of a predetermined time, the sucking by the membrane filtration pump 7 is stopped, and the valve 20 is closed. Subsequently, the treated water delivery pump 9 is started up, and the valve 21 is simultaneously opened. Thus, the permeate water 28 accumulated in the treated water tank 8 is injected into the separation membrane 5 through the backwashing pipe 10.

Through such backwashing operation, physically removable pollutants in the separation membrane 5 or physically removable pollutants adhering onto the surface of the separation membrane 5 are, for example, peeled off therefrom by water pressure, and thus the separation membrane 5 is physically washed.

The case in which the filtration step includes the backwashing operation is described in the first embodiment, but the backwashing operation is not always necessary and may be omitted. That is, it is also appropriate to simply leave the separation membrane 5 to stand still without filtration.

In addition, the filtration operation and the backwashing operation may be manually repeated by operating devices by an operation manager as need arises. Alternatively, those operations may be automatically repeated by, for example, installing a timer. In this case, labor saving is achieved. Whichever method, the manual one or the automatic one, is adopted, the effects of the present invention can be obtained just the same.

In addition, the operation time of the filtration step may similarly be manually adjusted by operating devices by an operation manager as need arises. Alternatively, it is also appropriate to perform the filtration step just for a preset time by, for example, installing a timer, or to finish the filtration step when the numbers of times of the filtration operation and the backwashing operation reach preset numbers by, for example, installing a counter.

Any method is adopted as long as the operation time of a single filtration step can be controlled. Further, when an ozone injection amount index R is calculated from an ozone injection amount calculated by the ozone injection amount measurement device 17 described later and the operation time of the filtration step, and the result is reflected in the next cycle, the effects of the present invention can be obtained.

In addition, while the filtration operation and the backwashing operation are performed, the permeate water 28 in the treated water tank 8 is transferred to the ozone dissolver 14 by the treated water delivery pump 9. In addition, when the water level in the treated water tank 8 is above a predetermined water level, the permeate water 28 is not only transferred to the ozone dissolver 14 but also discharged to the outside through the treated water discharge pipe 16. The valve 22 is in an open state at the time of transfer of the permeate water 28 to the ozone dissolver 14, and the valve 23 is in an open state at the time of discharge of the permeate water 28 to the outside. In addition, the switching operation may be performed by installing a three-way valve at an intersection point of the treated water transfer pipe 15 and the treated water discharge pipe 16.

(3) Determination Process for Switching Condition from Filtration Step to Ozone Injection Step

It is appropriate to install, for example, a pressure gauge as means capable of detect a transmembrane pressure difference, and when a value on the pressure gauge reaches a preset value, finish the filtration step and make transition to the ozone injection step. A value of transmembrane pressure difference detected with the pressure gauge is constantly monitored, and transferred to the ozone injection amount index calculation device 18.

<Ozone Injection Step>

When a transmembrane pressure difference detected with the pressure gauge reaches or exceeds a preset allowable value, for example, an allowable value set within a range of from 5 kPa to 100 kPa, the filtration step is finished. Moreover, after the filtration step is finished, the ozone injection step is started.

Now, the ozone injection step is described dividedly into generation of ozone water, injection of ozone water into the separation membrane, measurement of an ozone injection amount, and computation of an ozone injection amount index.

(1) Generation of Ozone Water

In the ozone injection step, first, an ozone gas generated with the ozone generator 12 is transferred to the ozone concentrator 13, and concentrated in the ozone concentrator 13. After that, concentrated ozone is discharged as a gas from the ozone concentrator 13, and injected into the ozone dissolver 14. The permeate water 28 is accumulated in the ozone dissolver 14 as described above, and ozone-containing water is produced by bringing the permeate water 28 and the ozone gas into contact with each other.

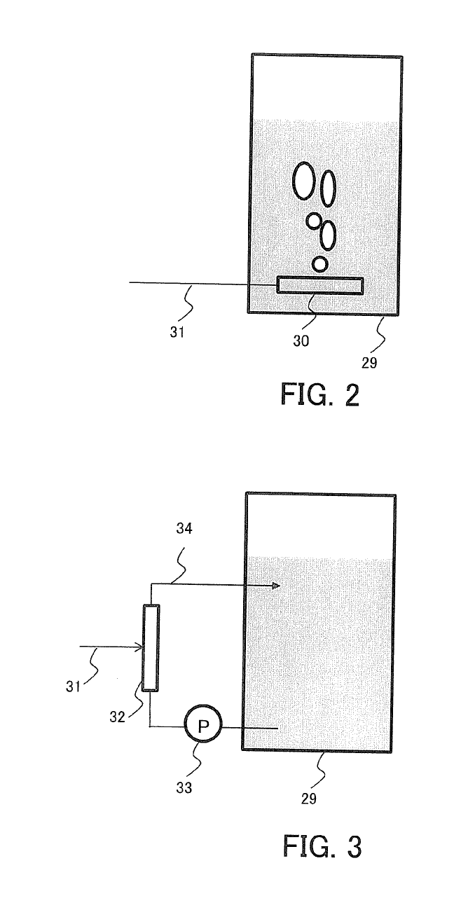

As an ozone dissolution method of the ozone dissolver 14, for example, a technique illustrated in FIG. 2 or FIG. 3 may be adopted. FIG. 2 is an explanatory view for illustrating an example of an ozone dissolution technique in the first embodiment of the present invention. In addition, FIG. 3 is an explanatory view for illustrating another example of the ozone dissolution technique in the first embodiment of the present invention, which is different from that of FIG. 2.

As illustrated in FIG. 2, an ozone diffuser 30 connected to an ozone introduction pipe 31 is arranged at a bottom portion of an ozone dissolution tank 29. Moreover, ozone is dissolved by blowing the ozone gas from the ozone diffuser 30 into the accumulated permeate water 28.

In addition, as illustrated in FIG. 3, it is also appropriate to dissolve ozone by arranging an ejector 32 connected to the ozone introduction pipe 31, and a circulation pump 33, and suctioning the ozone gas with the ejector 32 while the permeate water 28 is circulated through a circulation pipe 34 by the circulation pump 33. The ozone introduction pipe 31 in FIG. 2 and FIG. 3 is connected to the ozone concentrator 13.

When the ozone concentrator 13 is arranged, an ozone gas having an extremely high concentration of about 1,000 mg/NL can be obtained. As a result, ozone-containing water having a high concentration can be obtained, and with this, a high washing effect on the membrane can be obtained. However, the ozone concentrator is not always necessary in the present invention, and may be omitted as necessary.

When the ozone concentrator 13 is omitted, the ozone introduction pipe 31 is connected to the ozone generator 12, and the ozone gas is directly supplied from the ozone generator 12 to the ozone dissolver 14.

(2) Injection of Ozone Water into Separation Membrane

Ozone-containing water produced with the ozone dissolver 14 is injected into the separation membrane 5 through the ozone injection pipe 27. As an injection method, for example, ozone-containing water may be sent by pressure by, for example, mounting a pump to the ozone injection pipe 27, or may be injected by gravity by arranging the ozone dissolver 14 at a position higher than the water level in the biological treatment tank 4.

(3) Measurement of Ozone Injection Amount

An ozone injection amount in the ozone injection step is measured by the ozone injection amount measurement device 17. As described above, the ozone injection amount measurement device 17 includes: the measurement unit 35 with which, for an ozone-containing fluid flowing through the ozone injection pipe 27, at least parameters of an ozone concentration, a flow rate, and an ozone injection time can be measured; and the computing unit 36 configured to calculate an ozone injection amount from the measurement results.

In addition, the ozone injection amount measurement device 17 may be a device in which the measurement unit 35 and the computing unit 36 are integrated with each other, or may have a configuration in which only the measurement unit 35 is mounted to the ozone injection pipe 27, the computing unit 36 is independently arranged, and a signal is communicated therebetween by connecting these units with a signal line.

Further, the measurement unit 35 may be a device capable of measuring the above-mentioned parameters all at once, or may have a configuration in which an ozone concentration meter, a flow rate meter, a timer, and the like are separately arranged. Whatever the case, the measurement results of the parameters with the measurement unit 35 are communicated to the computing unit 36. Moreover, the computing unit 36 is configured to calculate an ozone injection amount by determining a product of an ozone concentration, a flow rate, and an ozone injection time based on the following expression (1).

Q=C×F×Ti (1)

Parameters in the expression (1) are as follows.

Q: ozone injection amount (mg O₃)

C: ozone concentration (mg O₃/L)

F: ozone-containing fluid flow rate (L/min)

Ti: ozone injection time (min)

There are no particular limitations on those parameters. However, when the ozone concentration C is too low, a washing effect and a modification effect on the separation membrane 5 are not sufficiently obtained. Therefore, it is desired to set the ozone concentration C to from 5 mg/L to 1,000 mg/L.

In addition, when the ozone injection time Ti is too short, the washing effect and modification effect on the separation membrane 5 are not sufficiently obtained again. Meanwhile, when the ozone injection time Ti is too long, treatment efficiency of the water treatment apparatus is reduced. Therefore, it is desired to set the ozone injection time Ti to from 5 minutes to 180 minutes, preferably from 5 minutes to 120 minutes.

In addition, it is desired to set the ozone-containing fluid flow rate F to such a value that about 0.2 L to about 20 L of the ozone-containing fluid is injected per unit area of the membrane in a single ozone injection step.

(4) Computation of Ozone Injection Amount Index

In the present invention, ozone injection conditions in the ozone injection step of each cycle are determined so that an ozone injection amount index R obtained from an ozone injection amount Q and an operation time Ts of the filtration step based on the following expression (2) satisfies the following expression (3).

R=Q/Ts (2)

Q1/Ts1≥Q2/Ts2 (3)

Parameters in the expressions (2) and (3) are as follows.

R: ozone injection amount index (mg O₃/min)

Q: ozone injection amount (mg O₃)

Ts: operation time of filtration step (min)

Q1: ozone injection amount of previous cycle (mg O₃)

Q2: ozone injection amount of current cycle (mg O₃)

Ts1: operation time of filtration step in previous cycle (min)

Ts2: operation time of filtration step in current cycle (min)

As a result of extensive investigations, the inventors of the present invention have found that, when the hydrophobic organic membrane is brought into contact alternately with ozone and a liquid free from ozone, rather than continuously brought into contact with ozone, and the ratio of an ozone injection amount to a passage time of the liquid free from ozone is gradually reduced, the hydrophobic membrane can be modified while a cumulative contact time with ozone is shortened.

For example, when the apparatus is operated with keeping the operation time of the filtration step constant through the cycles, it is appropriate to operate the apparatus so that the value of Q is reduced every cycle. Alternatively, it is also appropriate to operate the apparatus so that the operation time of the filtration step is increased every cycle.

The calculation of the ozone injection amount index R and determination of ozone injection conditions in the next cycle are performed by the ozone injection amount index calculation device 18. The ozone injection amount index calculation device 18 is a computing device capable of calculating the above-mentioned expression (3) and communicating the determined ozone injection conditions to the ozone injection device 11 and the ozone injection amount measurement device 17.

Specifically, the ozone injection amount index calculation device 18 may be, for example, a PLC or a C controller. In addition, when a computing device is arranged for controlling other devices, such as a pump and a valve, the ozone injection amount index calculation device 18 can double as a controller configured to perform overall control.

Further, when a configuration in which the computing unit 36 is arranged independently from the ozone injection pipe 27 and the computing unit 36 and the measurement unit 35 are connected through a signal line is adopted, the ozone injection amount index calculation device 18 can double as the computing unit 36. When the ozone injection step is finished, the filtration step is restarted.

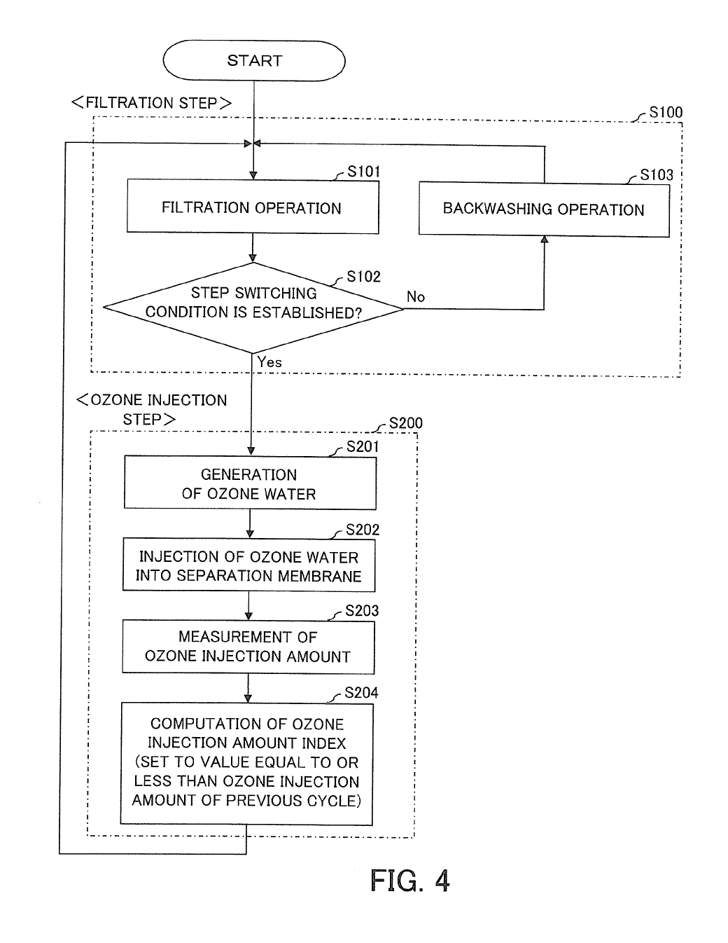

The above-mentioned operation of repeating a cycle including the filtration step and the ozone injection step is described in an organized way through use of a flowchart. FIG. 4 is a flowchart for illustrating a series of treatments in the water treatment method according to the first embodiment of the present invention in which the filtration step and the ozone injection step are repeated. The description using the flowchart of FIG. 4 is made given that the ozone injection amount index calculation device 18 doubles as a controller configured to perform overall control.

In the flowchart of FIG. 4, a series of treatments in which Step S100 serving as the filtration step and Step S200 serving as the ozone injection step are repeated is illustrated.

At first, a controller executes the above-mentioned filtration operation in Step S101 in the filtration step. Moreover, in Step S102, the controller determines whether or not a switching condition from the filtration step to the ozone injection step is satisfied. In the determination process, the controller detects a transmembrane pressure difference with a pressure gauge and compares the detected value and an allowable value as described above.

In addition, in the determination process, the controller may use a membrane property detector 24 or a transmembrane pressure difference detector 25 instead of the pressure gauge, the details of which are described in a second embodiment.

Moreover, when the controller determines that the switching condition from the filtration step to the ozone injection step is satisfied in Step S102, the controller proceeds with treatment of the ozone injection step of Step S200. Meanwhile, when the controller determines that the switching condition from the filtration step to the ozone injection step is not satisfied in Step S102, the controller proceeds with Step S103 to execute the backwashing operation, returns to Step S101, and repeatedly executes the filtration operation and beyond.

When the controller proceeds with the ozone injection step of Step S200, the controller generates ozone water in Step S201. Next, the controller executes injection of ozone water into the separation membrane 5 in Step S202. Next, the controller acquires an ozone injection amount measured with the ozone injection amount measurement device 17 in Step S203.

Moreover, the controller calculates the ozone injection amount index based on the above-mentioned expression (2) in Step S204. Further, the controller sets the ozone injection amount Q and the operation time Ts of the filtration step in the next cycle so that the ozone injection amount index of the next cycle is equal to or less than the ozone injection amount index of the current cycle as shown in the above-mentioned expression (3), and returns to the filtration step of Step S100.

Accordingly, as injection conditions for satisfying the above-mentioned expression (3), for example, the following settings are conceivable.
[Condition 1] The operation time Ts of the filtration step is kept constant through the cycles, and the ozone injection amount Q of each cycle is set to a value equal to or less than the ozone injection amount Q of its previous cycle.
[Condition 2] The ozone injection amount Q is kept constant through the cycles, and the operation time Ts of the filtration step of each cycle is set to a value equal to or more than the operation time Ts of the filtration step of its previous cycle.
[Condition 3] Both the operation time Ts of the filtration step and the ozone injection amount Q are kept constant through the cycles.

However, it is not always the case that the effects of the present invention are not obtained unless an automatic operation as illustrated in FIG. 4 is performed. For example, it is also appropriate to calculate the ozone injection amount index R every cycle and adjust the ozone injection conditions so as to satisfy the above-mentioned expression (3) by an operation manager.

In addition, under the state in which the ozone injection step has never been performed immediately after the start of the operation of the water treatment apparatus of the present invention, or under the state in which the operation is interrupted for maintenance or the like and then restarted, the ozone injection amount Q in the first ozone injection step may be set to from 300 mg O₃ to 3,000 mg O₃ per unit area of the membrane, that is, per square meter of the membrane.

In addition, in the first embodiment, the description is given of the case in which the ozone dissolver 14 is arranged to produce ozone-containing water, and the ozone-containing water is injected as an ozone-containing fluid into the separation membrane 5. However, the effects of the present invention are obtained even when the operation is performed so that an ozone gas is directly injected into the separation membrane 5. In this case, the ozone dissolver 14 may be omitted, and ozone is injected directly from any one of the ozone generator 12 and the ozone concentrator 13 into the separation membrane 5 through the ozone injection pipe 27. Further, the filtration membrane may be washed with ozone-containing water while the ozone-containing water is produced.

As described above, according to the first embodiment, there is adopted a configuration in which water treatment is performed so that the hydrophobic organic membrane is not brought into contact continuously with ozone, but brought into contact alternately with ozone and a liquid free from ozone, and the ratio of the ozone injection amount to a passage time of the liquid free from ozone is kept at the same level or gradually reduced.

In other words, the water treatment apparatus according to the first embodiment has a technical feature of performing the water treatment as follows: a cycle including: a “filtration step” of filtering water to be treated through a hydrophobic organic membrane; and an “ozone injection step” of, after interrupting the filtration step, injecting an ozone-containing fluid into the hydrophobic organic membrane is repeated; and an “ozone injection amount index” obtained by dividing an ozone injection amount in the ozone injection step by an operation time of the filtration step is calculated every cycle, and the ozone injection amount index of the next cycle is set to a value equal to or less than the ozone injection amount index of the current cycle having been calculated.

As a result, there is achieved a water treatment method and a water treatment apparatus which, in a water treatment technology using a hydrophobic organic membrane, enable long-term stable filtration without using special pretreatment and a special facility through modification of the hydrophobic membrane in an extremely short contact time with ozone as compared to those in the related art.

### Second Embodiment

In a second embodiment of the present invention, description is given of a water treatment apparatus capable of reducing the usage amount of ozone by eliminating unnecessary washing with ozone.

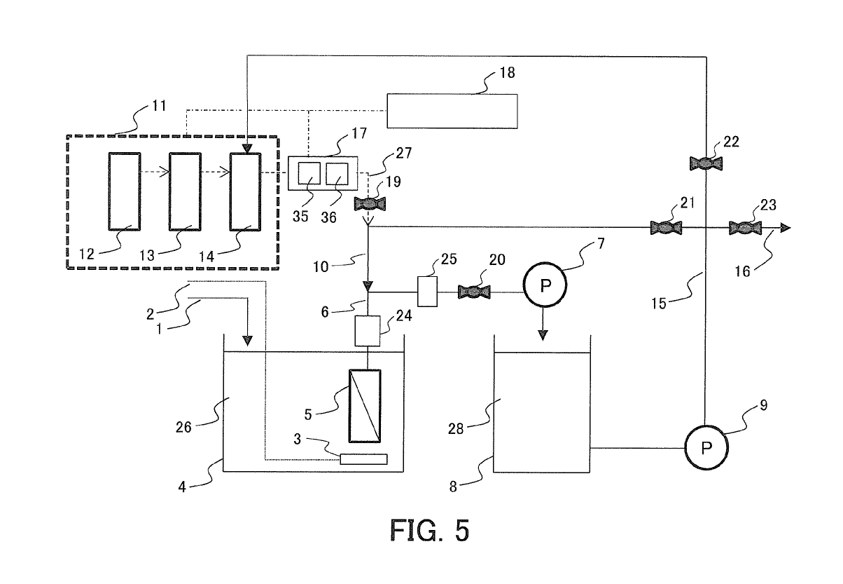

FIG. 5 is a view for illustrating an entire water treatment system in the case of applying a water treatment apparatus according to the second embodiment of the present invention to an immersed membrane bioreactor. When the configuration of FIG. 5 of the second embodiment is compared to the configuration of FIG. 1 of the preceding first embodiment, the configuration of FIG. 5 differs from the configuration of FIG. 1 in that the membrane property detector 24 and the transmembrane pressure difference detector 25 are further mounted to the permeate water transfer pipe 6. In view of the foregoing, the description is given with a focus on those differences.

As specifically described in the preceding first embodiment, the present invention enables long-term stable filtration by bringing ozone into contact with the separation membrane 5 to modify the hydrophobic membrane. Herein, after the completion of the modification of the hydrophobic membrane, filtration can be performed stably for an extremely long period of time. Therefore, after the completion of the modification, the frequency of washing of the membrane with ozone may be significantly reduced. In fact, unnecessary washing unnecessarily leads to an increase in usage amount of ozone, and is uneconomical.

Therefore, the membrane property detector 24 is configured to appropriately check the state of the membrane, that is, the degree of modification of the membrane, in a quantitative way. Moreover, after a determination is made by the membrane property detector 24 that the modification is sufficiently performed, it is desired to execute water treatment so that the ozone injection step is started only when blocking occurs in the membrane, that is, a transmembrane pressure difference detected with the transmembrane pressure difference detector 25 increases.

A threshold value of a pressure detected with the transmembrane pressure difference detector 25 at which the filtration step is switched to the ozone injection step is desirably set within a range of from 2 kPa to 100 kPa, preferably from 3 kPa to 30 kPa, more preferably from 5 kPa to 20 kPa. In other words, when a filtration membrane subjected to hydrophilic treatment or a filtration membrane modified in advance is used, the ozone injection amount index R is not always required to be reduced, and filtration may be continued while the ozone injection amount index R is kept constant through the cycles.

As a matter of course, filtration may be continued by randomly combining the case in which the ozone injection amount index R is kept constant through the cycles and the case in which the ozone injection amount index R is reduced every cycle. A hydrophilization method is not limited to the method involving using ozone, and the same applies to a case of using another oxidant, such as hydrogen peroxide.

A conventional washing step of a filtration membrane involves using a chemical, such as an aqueous solution of sodium hypochlorite, which has weak oxidizing power. Therefore, a substance which clogs the filtration membrane is not completely removed, and is accumulated. As a result, as a cycle including a membrane filtration step and a washing step of a membrane with a chemical is repeated more, it becomes necessary to prolong a washing time or increase the concentration of the chemical.

In contrast to the foregoing, the inventors of the present invention have found the following facts.
When the filtration membrane can be brought back to its unfiltered state through washing with ozone-containing water.
As a cycle including a membrane filtration step and a washing step of the membrane with ozone-containing water is repeated more, a washing time or the concentration of ozone-containing water can be set to a value equal to or less than that of the previous cycle.
As a result, an increase in acquisition amount of filtered water can be achieved by virtue of a shortened washing time, and further, the lifetime of the membrane, which is reduced owing to clogging, can be extended.

Ozone reacts with iron or manganese to generate a precipitate, and hence it is desired to remove these substances in advance with a filter or the like.

It has been found that, particularly when activated sludge is present on the primary side of membrane filtration, that is, in the case of a membrane bioreactor, the filtration membrane is increased in permeability by repeating the cycle of the present invention, with the result that an effect of capable of stably continuing filtration becomes remarkable. This is attributed to the following: organic matter which has clogged the filtration membrane reacts with ozone, and a state in which part of the organic matter which is reduced in molecular weight and hydrophilized adheres onto the filtration membrane is maintained, and thus the filtration membrane is increased in permeability.

That is, the ozone injection step of the present invention is a breakthrough washing step, in which not only the hydrophilicity of the material of the filtration membrane is increased, but also the permeability of the filtration membrane is increased by modifying the organic matter adhering onto the filtration membrane and utilizing the organic matter. This is realized by hydrophilizing the material of the filtration membrane, such as PVDF, and besides, forming a layer of highly hydrophilic organic matter on the surface of the filtration membrane so as to form a thin skin.

Further, when the cycle of the present invention is repeated, an area of the layer of the adhering organic matter is gradually expanded in the filtration membrane, and the permeability of the filtration membrane is increased. As a result, operation can be performed with less clogging when the ozone injection amount index R is kept constant through the cycles or the ozone injection amount index R of each cycle is set to a value equal to or less than that of its previous cycle, or these operations are randomly combined.

This is an event which has not been found when the washing of the filtration membrane with ozone-containing water is merely repeated, and is clarified when evaluation is performed with a focus on the permeability of the filtration membrane as in the case of the present invention.

A specific example of the membrane property detector 24 is a pressure gauge. That is, when an injection pressure of the ozone-containing fluid into the membrane on the pressure gauge falls below a preset pressure threshold value immediately after the start of the ozone injection step, it can be determined that the membrane is modified sufficiently. It is desired to set the pressure threshold value within a range of, for example, from 2 kPa to 100 kPa, preferably from 3 kPa to 30 kPa, more preferably from 5 kPa to 20 kPa.

Only the transmembrane pressure difference detector 25 may be used at the time of membrane filtration without using the membrane property detector 24. Specifically, for example, the membrane property detector 24 and the transmembrane pressure difference detector 25 may adopt an ultrasonic detection method for membrane properties. The detection method involves radiating ultrasonic waves to the separation membrane 5, and sensing the presence or absence of matter adhering onto the membrane based on the intensity of a reflected wave or on a ratio in intensity between the reflected wave and a radiated wave.

It is also appropriate to use, as an indicator of a clogging state of the membrane, a difference in concentration of dissolved organic matter before and after the membrane filtration, that is, a difference between a concentration A of dissolved organic matter in unfiltered water on the primary side and a concentration B of dissolved organic matter in filtered water on the secondary side, A-B. With this, the amount of organic matter accumulated on the filtration membrane can be indirectly grasped. The value of A-B tends to be higher when activated sludge is present on the primary side of the membrane than when sewage secondary effluent, raw water for clean water, river water, industrial water, or the like is present on the primary side of the membrane.

When the value of A-B varies to a large extent, it is considered that a larger amount of organic matter adheres onto the filtration membrane. When the value of A-B is used as an indicator and the indicator is kept at a certain value or less, membrane filtration operation can be performed stably.

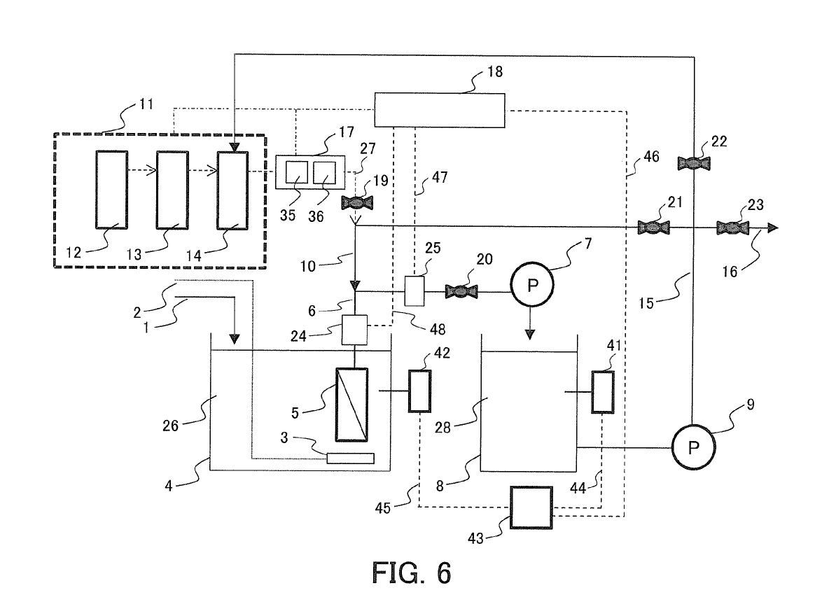

Now, a configuration of a system in which membrane filtration operation is performed through use of the value of A-B as an indicator of clogging is described with reference to FIG. 6. FIG. 6 is a view for illustrating another entire water treatment system in the case of applying the water treatment apparatus according to the second embodiment of the present invention to the immersed membrane bioreactor, which is different from that of FIG. 5. The configuration illustrated in FIG. 6 is based on the configuration of FIG. 5, and further includes: a dissolved organic matter concentration measurement unit 42 mounted to the biological treatment tank 4 for measuring the concentration A of dissolved organic matter in unfiltered water on the primary side; and a dissolved organic matter concentration measurement unit 41 mounted to the treated water tank 8 for measuring the concentration B of dissolved organic matter in filtered water on the secondary side.

Moreover, the dissolved organic matter concentration measurement unit 42 is connected to a trial calculation unit 43 for difference in concentration of dissolved organic matter through a signal line 45, and the dissolved organic matter concentration measurement unit 41 is connected to the trial calculation unit 43 for difference in concentration of dissolved organic matter through a signal line 44. Further, the trial calculation unit 43 for difference in concentration of dissolved organic matter is connected to the ozone injection amount index calculation device 18 through a signal line 46.

In addition, the membrane property detector 24 is connected to the ozone injection amount index calculation device 18 through a signal line 48, and the transmembrane pressure difference detector 25 is connected to the ozone injection amount index calculation device 18 through a signal line 47.

Next, operation of the system illustrated in FIG. 6 is described. The values of the concentration A of dissolved organic matter in the biological treatment tank 4 measured with the dissolved organic matter concentration measurement unit 42 and the concentration B of dissolved organic matter in the treated water tank 8 measured with the dissolved organic matter concentration measurement unit 41 are sent to the trial calculation unit 43 for difference in concentration of dissolved organic matter through the signal lines 45 and 44, respectively.

The trial calculation unit 43 for difference in concentration of dissolved organic matter calculates a difference between the concentration A of dissolved organic matter in the biological treatment tank 4 and the concentration B of dissolved organic matter in the treated water tank 8, A-B, and sends the calculation result to the ozone injection amount index calculation device 18 through the signal line 46. As a result, the washing step is started based on the value of A-B.

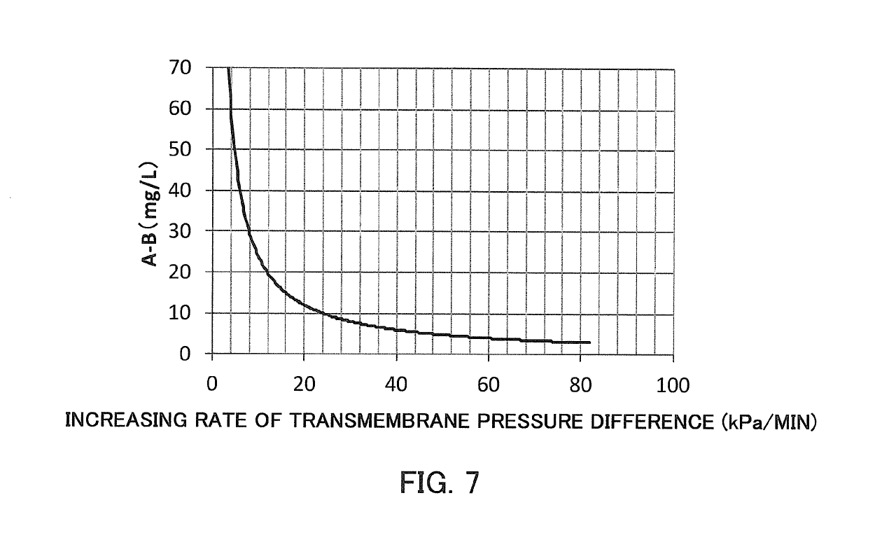

FIG. 7 is a graph for showing a relationship: between a difference between the concentration A of dissolved organic matter in the biological treatment tank 4 and the concentration B of dissolved organic matter in the treated water tank 8, A-B; and an increasing rate of a transmembrane pressure difference in the second embodiment of the present invention. As the value of A-B becomes smaller, the increasing rate of a transmembrane pressure difference becomes higher.

Given that n represents the current cycle and n+1 represents the next cycle. When the value of A-B is, for example, 25 mg/L or more, which indicates that the amount of organic matter adhering onto the membrane is large, the washing step with ozone may be controlled so that the following holds true: Qn/Tsn=(Qn+1)/(Tsn+1). Meanwhile, when the value of A-B is less than 25 mg/L, the washing step with ozone may be controlled so that the following holds true: Qn/Tsn>(Qn+1)/(Tsn+1).

The value of A-B is preferably set within a range of from 5 mg/L to 40 mg/L. When the value of A-B is less than 5 mg/L, the clogging amount in the separation membrane is too small, and the number of times of transition to the washing step with ozone water is increased, which is not economical. Meanwhile, when the value of A-B is more than 40 mg/L, the clogging amount in the separation membrane is too large, and it becomes difficult to obtain a washing effect, with the result that the filtration cannot be performed.

Herein, the ozone injection amount index calculation device 18 may determine whether or not to switch to the ozone injection step through use of all indicators of the value of transmembrane pressure difference detected with the transmembrane pressure difference detector 25, the value of A-B, and the intensity of the reflected ultrasonic wave. Specifically, for each of the indicators, a threshold value for determining that the filtration step is switched to the ozone injection step is set in advance, and the first time any one of the indicators reaches its threshold value, the filtration step may be switched to the ozone injection step.

Alternatively, switching to the ozone injection step may be performed through use of any indicator of the value of transmembrane pressure difference detected with the transmembrane pressure difference detector 25, the value of A-B, and the intensity of the reflected ultrasonic wave. In particular, a method capable of controlling the water treatment of the present invention with the highest precision is a method involving using only the value of transmembrane pressure difference.

For the ultrasonic waves, a frequency of from 10 MHz to 2,000 MHz and an intensity of from 1 W to 1,000 W are preferably used. Further, a ratio in intensity between the reflected wave and the radiated wave, that is, a ratio of the intensity of the reflected wave to the intensity of the radiated wave is preferably set within a range of from 0.1 to 0.9.

In the present invention, ozone is injected into the filtration membrane 5 in the ozone injection step. Therefore, ozone which has not been consumed in the filtration membrane 5 is introduced into the biological treatment tank 4 through the filtration membrane 5. Ozone introduced into the biological treatment tank 4 reacts with activated sludge or dissolved organic matter in the biological treatment tank 4 to oxidize these substances.

Through such reaction, low-biodegradable organic matter accumulated in the biological treatment tank 4 or high-molecular organic matter liable to adhere onto the filtration membrane, such as a protein or a sugar, is reduced in molecular weight with ozone. As a result, an effect of increasing the activity of the activated sludge, and besides, converting such organic matter into a substance less liable to adhere onto the filtration membrane 5 is obtained.

In the preceding first embodiment, the description is given of the case in which a pressure gauge is used to measure the transmembrane pressure difference when a determination is made as to “Step switching condition is established?” in Step S102 of the flowchart of FIG. 4. In contrast to this, in the second embodiment, the membrane property detector 24, the transmembrane pressure difference detector 25, or an ultrasonic sensor may be used as an alternative as a sensor for detecting the transmembrane pressure difference in the determination process in Step S102 as described above.

In a cycle after it has been determined that the modification of the membrane is sufficiently performed, the ozone injection step is started in accordance with the value of transmembrane pressure difference detected with the transmembrane pressure difference detector 25. As a guide, the ozone injection step is desirably started when the value of transmembrane pressure difference reaches a value within a range of from 10 kPa to 50 kPa, preferably from 15 kPa to 50 kPa.

In the second embodiment, the case in which the membrane property detector 24 and the transmembrane pressure difference detector 25 are separately mounted is described. However, when a pressure gauge is used as the membrane property detector 24, it is also appropriate to omit the transmembrane pressure difference detector 25 and detect the transmembrane pressure difference with the membrane property detector 24.

As described above, according to the second embodiment, there is adopted a configuration in which the modification state of the hydrophobic membrane is monitored in a quantitative way, and when it can be determined that the modification is sufficiently performed, unnecessary washing with ozone can be eliminated. As a result, a reduction in usage amount of ozone can be achieved in addition to the effects of the preceding first embodiment.

### SPECIFIC EXAMPLES

For the water treatment apparatus illustrated in FIG. 2, the effects of the present invention were examined by way of Examples based on specific data. A pressure gauge was used as the transmembrane pressure difference detector 25 without using the membrane property detector 24. A hollow fiber membrane module using a microfiltration membrane made of PVDF was used as a membrane. Under each of the conditions, a cumulative operation time of the filtration step was unified to 1,800 minutes.

Urban sewage water was used as water to be treated, and was treated through use of activated sludge. Water in an amount required in a testing period was sampled at once, and was stirred to be homogenized in a tank separately prepared. In addition, four separation membranes 5 were simultaneously immersed in the biological treatment tank 4. Thus, experiments of Example 1, Example 2, Example 3, and Comparative Example 1 described below were each performed. That is, for all the separation membranes, the conditions of variations in water quality of the water to be treated and properties of the activated sludge were the same.

Each membrane has a filtration area of 0.1 m². In addition, when the water level was increased through injection of ozone-containing water, the sludge was extracted from an aeration tank or sludge separately concentrated was added as necessary, to thereby keep the water level and the concentration of the sludge constant.

### Example 1

The separation membranes 5 were washed by setting the ozone water concentration C, ozone water flow rate F, and ozone injection time Ti so that Q per unit area of the membrane was 1,600 mg O₃/m² in the first cycle. After that, a cycle including filtration and washing was repeated by keeping the ozone water concentration C and flow rate F constant and changing only the ozone injection time Ti.

After the cycle was repeated five times, the membranes were removed from the tank, and the surfaces of the separation membranes 5 were washed with tap water. Subsequently, the separation membranes 5 were transferred into a tank filled with ultrapure water, and measured for a pure water filtration pressure difference at a water temperature of 25° C. Through the examination of Example 1, the results shown in Table 1 below were obtained.

TABLE 1

| Cycle | First | Second | Third | Fourth | Fifth | Total |
|---|---|---|---|---|---|---|
| Ozone water concentration C | 40 | 40 | 40 | 40 | 40 | — |
| (mg O₃/L) | | | | | | |
| Ozone water flow rate F | 50 | 50 | 50 | 50 | 50 | — |
| (50 mL/min) | | | | | | |
| Ozone injection time Ti (min) | 80 | 35 | 20 | 10 | 5 | 150 |
| Ozone injection amount Q | 160 | 70 | 40 | 20 | 10 | 300 |
| (mg O₃) | | | | | | |
| Operation time Ts of | 360 | 360 | 360 | 360 | 360 | 1,800 |
| filtration step (min) | | | | | | |
| Ozone injection amount | 0.44 | 0.19 | 0.11 | 0.06 | 0.03 | — |
| index R (mg O₃/min) | | | | | | |
| Q per unit area of membrane | 1,600 | 700 | 400 | 200 | 100 | 3,000 |
| (mg O₃/m²) | | | | | | |
| Water passage amount per | 40 | 17.5 | 10 | 5 | 2.5 | |
| unit area of membrane | | | | | | |
| (L/m²) | | | | | | |

### Example 2

The separation membranes 5 were washed by setting the ozone water concentration C, ozone water flow rate F, and ozone injection time Ti so that Q per unit area of the membrane was 600 mg O₃/m² in the first cycle. After that, a cycle including filtration and washing was repeated by keeping the ozone injection amount Q constant and changing only the ozone injection time Ti.

After the cycle was repeated five times, the membranes were removed from the tank, and the surfaces of the separation membranes 5 were washed with tap water. Subsequently, the separation membranes 5 were transferred into a tank filled with ultrapure water, and measured for a pure water filtration pressure difference at a water temperature of 25° C. Through the examination of Example 2, the results shown in Table 2 below were obtained.

TABLE 2

| Cycle | First | Second | Third | Fourth | Fifth | Total |
|---|---|---|---|---|---|---|
| Ozone water concentration C | 40 | 40 | 40 | 40 | 40 | — |
| (mg O₃/L) | | | | | | |
| Flow rate F (50 mL/min) | 50 | 50 | 50 | 50 | 50 | — |
| Ozone injection time Ti (min) | 30 | 30 | 30 | 30 | 30 | 150 |
| Ozone injection amount Q | 60 | 60 | 60 | 60 | 60 | 300 |
| (mg O₃) | | | | | | |
| Operation time Ts of | 120 | 180 | 360 | 540 | 600 | 1,800 |
| filtration step (min) | | | | | | |
| Ozone injection amount | 0.500 | 0.333 | 0.167 | 0.111 | 0.100 | — |
| index R (mg O₃/min) | | | | | | |
| Q per unit area of membrane | 600 | 600 | 600 | 600 | 600 | 3,000 |
| (mg O₃/m²) | | | | | | |
| Water passage amount per | 15 | 15 | 15 | 15 | 15 | |
| unit area of membrane | | | | | | |
| (L/m²) | | | | | | |

### Example 3

The separation membranes 5 were washed by setting the ozone water concentration C, ozone water flow rate F, and ozone injection time Ti so that Q per unit area of the membrane was 600 mg O₃/m². A cycle including washing was repeated by keeping the ozone injection amount index R constant.

After the cycle was repeated five times, the membranes were removed from the tank, and the surfaces of the separation membranes 5 were washed with tap water. Subsequently, the separation membranes 5 were transferred into a tank filled with ultrapure water, and measured for a pure water filtration pressure difference at a water temperature of 25° C. Through the examination of Example 3, the results shown in Table 3 below were obtained.

TABLE 3

| Cycle | First | Second | Third | Fourth | Fifth | Total |
|---|---|---|---|---|---|---|
| Ozone water concentration C | 40 | 40 | 40 | 40 | 40 | — |
| (mg O₃/L) | | | | | | |
| Flow rate F (50 mL/min) | 50 | 50 | 50 | 50 | 50 | — |
| Ozone injection time Ti (min) | 30 | 30 | 30 | 30 | 30 | 150 |
| Ozone injection amount Q | 60 | 60 | 60 | 60 | 60 | 300 |
| (mg O₃) | | | | | | |
| Operation time Ts of | 360 | 360 | 360 | 360 | 360 | 1,800 |
| filtration step (min) | | | | | | |
| Ozone injection amount | 0.167 | 0.167 | 0.167 | 0.167 | 0.167 | — |
| index R (mg O₃/min) | | | | | | |
| Q per unit area of membrane | 600 | 600 | 600 | 600 | 600 | 3,000 |
| (mg O₃/m²) | | | | | | |
| Water passage amount per | 15 | 15 | 15 | 15 | 15 | |
| unit area of membrane (L/m²) | | | | | | |

### Comparative Example 1

The separation membranes 5 were washed once by setting the ozone water concentration C, ozone water flow rate F, and ozone injection time Ti so that Q per unit area of the membrane was 36,000 mg O₃/m². Subsequently, the separation membranes 5 were transferred into a tank filled with ultrapure water, and measured for a pure water filtration pressure difference at a water temperature of 25° C. Through the examination of Comparative Example 1, the results shown in Table 4 below were obtained.

TABLE 4

| Cycle | First | Total |
|---|---|---|
| Ozone water concentration C (mg O₃/L) | 40 | — |
| Flow rate F (50 mL/min) | 50 | — |
| Ozone injection time Ti (min) | 1,800 | 1,800 |
| Ozone injection amount Q (mg O₃) | 3,600 | 3,600 |
| Operation time Ts of filtration step (min) | 0 | 0 |
| Ozone injection amount index R (mg O₃/min) | — | — |
| Q per unit area of membrane (mg O₃/m²) | 36,000 | |
| Water passage amount per unit area of membrane | 900 | |
| (L/m²) | | |

The results of the pure water filtration pressure difference across the modified filtration membranes measured through the examinations of Examples 1 to 3 and Comparative Example 1 described above are summarized in Table 5 below.

TABLE 5

| | Without | | | | Compar- |
|---|---|---|---|---|---|
| | washing with | | | | ative |
| | ozone water | Example 1 | Example 2 | Example 3 | Example 1 |
| Pure water | 8 | 1.1 | 1.3 | 0.9 | 4.7 |
| filtration | | | | | |
| pressure | | | | | |
| difference | | | | | |
| (kPa) | | | | | |

In Table 5 above, a case without washing with ozone water was additionally shown as a reference. From the results shown in Table 5, it is revealed that a sufficient hydrophilizing effect on the filtration membrane can be obtained in a short time by the washing methods of Examples 1 to 3. Accordingly, it is apparent that the present invention has an advantage over existing inventions.

1. A water treatment method, in which a cycle including: a filtration step of filtering water to be treated through a separation membrane from a primary side to a secondary side of the separation membrane; and a backwashing step of washing the separation membrane from the secondary side to the primary side is repeated,
the water treatment method comprising the steps of:
injecting, into the separation membrane, ozone to be used in the backwashing step; and
when, of the repeated cycles, a previous cycle is defined as a first cycle and a following cycle subsequent to the first cycle is defined as a second cycle, setting an ozone injection amount to be injected in the second cycle to a value equal to or less than an ozone injection amount injected in the first cycle.

2. A water treatment method according to claim 1, wherein an operation time of the filtration step in the second cycle is set to a value equal to an operation time of the filtration step in the first cycle.

3. A water treatment method according to claim 1, wherein an operation time of the filtration step in the second cycle is set to a value less than an operation time of the filtration step in the first cycle.

4. A water treatment method according to claim 1, further comprising the steps of:
detecting a value of transmembrane pressure difference across the separation membrane; and
making transition from the filtration step to the backwashing step based on the detected value of transmembrane pressure difference.

5. A water treatment method according to claim 1, further comprising the steps of:
detecting, as a value of transmembrane pressure difference, a difference between a concentration of dissolved organic matter on the primary side and a concentration of dissolved organic matter on the secondary side; and
making transition from the filtration step to the backwashing step based on the detected value of transmembrane pressure difference.

6. A water treatment method according to claim 1, further comprising the steps of:
calculating an indicator of a clogging state of the separation membrane from a membrane property measurement result with an ultrasonic sensor; and
making transition from the filtration step to the backwashing step based on the calculated indicator of a clogging state.

7. A water treatment method according to claim 1, wherein:
a microbial community is present on the primary side and treated water is present on the secondary side in the filtration step; and
the microbial community is present on the primary side and ozone-containing water is present on the secondary side in the backwashing step.

8. A water treatment apparatus, in which a cycle including: filtration treatment of filtering water to be treated through a separation membrane; and backwashing treatment of washing the separation membrane is repeated,
the water treatment apparatus comprising:
an ozone injection unit configured to inject, into the separation membrane, ozone to be used in the backwashing treatment; and
a control unit configured to control an ozone injection amount to be injected into the separation membrane by the ozone injection unit,
wherein the control unit is configured to control the ozone injection amount so that, when, of the repeated cycles, a previous cycle is defined as a first cycle and a following cycle subsequent to the first cycle is defined as a second cycle, an ozone injection amount in the second cycle is set to a value equal to or less than an ozone injection amount in the first cycle.

9. A water treatment apparatus according to claim 8, further comprising a transmembrane pressure difference detector configured to detect a transmembrane pressure difference across the separation membrane,
wherein the control unit is configured to control timing to make transition from the filtration treatment to the backwashing treatment based on the transmembrane pressure difference detected with the transmembrane pressure difference detector.
